(19) United States
(12) Patent Application Publication
(10) Pub. No.: US 2024/0266104 A1
(43) Pub. Date: Aug. 8, 2024

(54) COUPLED INDUCTOR STRUCTURE IN TLVR TECHNOLOGY AND MULTI-PHASE VOLTAGE REGULATOR MODULE USING SAME

(71) Applicant: SHANGHAI METAPWR ELECTRONICS CO. , LTD, Shanghai (CN)

(72) Inventor: Mingzhun ZHANG, Shanghai (CN)

(73) Assignee: SHANGHAI METAPWR ELECTRONICS CO. , LTD, Shanghai (CN)

(21) Appl. No.: 18/423,233

(22) Filed: Jan. 25, 2024

(30) Foreign Application Priority Data
Feb. 6, 2023 (CN) 202310091264.1

(51) Int. Cl. H01F 27/28; H01F 27/24

(52) U.S. Cl. CPC H01F 27/28; H01F 27/24

(57) ABSTRACT

An inductor structure in a TLVR technology and a multi-phase voltage regulator module using the same are provided. The inductor structure includes a magnetically permeable core and at least one coupled winding combination, wherein the coupled winding combination includes at least one main winding and at least one auxiliary winding. At least one portion of each main winding is coupled with at least one portion of at least one auxiliary winding. The inductor structure has opposing first surface and second surface. Two ends of the main winding are respectively exposed out of the magnetically permeable core on the first surface and the second surface. And two ends of the auxiliary winding are respectively exposed out of the magnetically permeable core on the first surface and the second surface.

### CROSS-REFERENCE TO RELATED APPLICATION

This application claims the priority benefit of China application Ser. No. 202310091264.1 filed on Feb. 6, 2023. The entirety of the above-mentioned patent application is hereby incorporated by reference herein and made a part of this specification.

### BACKGROUND

### Technical Field

The invention relates to a high-frequency power supply, in particular to a coupled inductor structure in TLVR technology and a multi-phase voltage regulator module using the same.

### Description of Related Art

At present, with the development of artificial intelligence, intelligent data processing chips, such as GPU CPU NPU and the like (collectively referred to as XPU), have increasingly power requirements, so that the power of a server is increased, and power is gradually supplied from 12V to 48V for power supply. The operating voltage of the XPU becomes increasingly lower with the process improving. Therefore, the power supply voltage difference becomes larger and larger, so that the two-stage circuit becomes mainstream step by step.

In recent years, with the development of technologies such as data centers, artificial intelligence, supercomputers and so on, more and more powerful ASICs are applied, such as CPU, GPU, machine learning accelerator, network switch, server, etc., which consume a large amount of current, such as thousands of amps, and their power demand fluctuates quickly. Traditionally a multi-phase voltage regulator (VR) is used to supply such a load. To meet the requirements of increasing the load current and continuously increasing the bandwidth, the number of phases of VR and the capacitance of the output decoupled capacitors thereof are increased. These manners improve the transient response of the traditional VR to some extent. However, due to the larger output impedance, the space occupied by the decoupled capacitor and the distance between the decoupled capacitor and the load, the traditional VR has reached the performance limit in the transient response aspect. Other techniques for traditional VR are improved, such as increasing switching frequency and/or reducing inductance values, improving transient response, but at the expense of efficiency reduction. The anti-coupled inductor technology has a relatively low leakage inductance, and therefore has a relatively fast transient response. Meanwhile, the anti-coupled inductor has a relatively high steady-state equivalent inductance, which is beneficial to improving the efficiency. That is, the anti-coupled inductor technology not only can meet the requirements of transient performance, but also can improve the efficiency, so that the anti-coupled technology is a hotspot in VR design. However, because the multi-phase coupled inductor includes a plurality of windings, and the plurality of windings need to be physically coupled with each other, the manufacturing difficulty is high, and the application is not flexible enough. A Trans-Inductor Voltage Regulator (hereinafter referred to as TLVR) technology can realize coupling of multiple phases of mutually independent inductors physically without a coupled relationship through an auxiliary winding, and to solve the difficulty in manufacturing a multi-phase coupled inductor.

FIG. 1A is a schematic circuit diagram of the TLVR technology. As shown in FIG. 1A, the main inductor L1, L2, L3, and L4 are independent inductors having no coupled relationship with each other, but the auxiliary windings L10, L20, L30, L40 are respectively coupled with the main inductors L1, L2, L3, L4. The auxiliary windings L10, L20, L30, L40 can be directly connected end to end, or an external compensation inductor Le is added to the loop of the auxiliary winding. Therefore, the independent main inductors L1, L2, L3 and L4 which do not have a coupled relationship with each other are equivalent to a four-phase anti-coupled inductor having a coupled relationship between any two phases shown in FIG. 1B.

FIG. 2A and FIG. 2B are circuit diagrams and equivalent circuit diagrams of an N-phase TLVR technology respectively.

The main inductor in FIG. 1A, FIG. 1B, FIG. 2A and FIG. 2B may also be a multi-phase coupled inductor having a coupled relationship between any two phases through the auxiliary winding after two-phase coupling.

This application mainly provides different structures and coupled forms of a main winding and an auxiliary winding in a series of TLVR, and a method for realizing a multi-phase anti-coupled inductor by a plurality of two-phase inductors through the TLVR technology.

### SUMMARY

In view of this, the object of this application is to provide an inductor structure in a TLVR technology, which enables a multi-phase inductor to have a coupled characteristic by using the TLVR technology, so that a switch device on a top surface is closer to a radiator while a voltage regulator module (VRM) achieves better dynamic performance, thereby enhancing the heat dissipation capability of the VRM and improving the power density of the VRM.

Another object of this application further provides a multi-phase voltage regulator module using the above inductor structure.

In general, one aspect features an apparatus, comprising:
a magnetically permeable core and at least one coupled winding combination,
wherein the coupled winding combination comprises at least one main winding and at least one auxiliary winding; at least one portion of each main winding is coupled with at least one portion of at least one auxiliary winding;
wherein the apparatus has opposing first surface and second surface; two ends of the main winding are respectively exposed out of the magnetically permeable core on the first surface and the second surface; and two ends of the auxiliary winding are respectively exposed out of the magnetically permeable core on the first surface and the second surface.

Optionally, at least one portion of at least one main winding is a first main winding segment, and at least one portion of at least one auxiliary winding is a first auxiliary winding segment;
at least one portion of the main winding coupled with at least one portion of at least one auxiliary winding is specifically: the first main winding segment and the first auxiliary winding segment arranged side by side in parallel; a non-magnetic material or a magnetic material with a magnetic conductivity lower than that of the magnetically permeable core is set in an interval space between the first main winding segment and the first auxiliary winding segment.

Optionally, all of the at least one main winding is the first main winding segment, and all of the at least one auxiliary winding is the first auxiliary winding segment;
wherein the coupling coefficient of the at least one main winding and the at least one auxiliary winding is greater than 0.85.

Optionally, the coupled winding combination comprises two main windings and at least two auxiliary windings; at least one portion of one of the main windings is a third main winding segment, at least one portion of the other main winding is a fourth main winding segment; and the third main winding segment is coupled with the fourth main winding segment.

Optionally, the third main winding segment couples with the fourth main winding segment; the third main winding segment and the fourth main winding segment are arranged side by side or in parallel; and a non-magnetic material or a magnetic material with a magnetic conductivity lower than that of the magnetically permeable core is set in an interval space between the third main winding segment and the fourth main winding segment.

Optionally, at least one portion of the at least one auxiliary winding corresponding to the third main winding segment is a third auxiliary winding segment, and at least one portion of the at least one auxiliary winding corresponding to the fourth main winding segment is a fourth auxiliary winding segment;
the third auxiliary winding segment is coupled with the third main winding segment; the fourth auxiliary winding segment is coupled with the fourth main winding segment;
the third auxiliary winding segment and the fourth auxiliary winding segment are arranged side by side between the third main winding segment and the fourth main winding segment.

Optionally, the coupled winding combination comprises two main windings and at least one auxiliary winding; one of the main windings is a first main winding, and the other main winding is a second main winding;
wherein a portion of the first main winding is a first main winding segment, and a portion of the second main winding is a second main winding segment; a portion of the auxiliary winding is a first auxiliary winding segment, and the other portion is a second auxiliary winding segment; the first auxiliary winding segment is coupled with the first main winding segment, and the second auxiliary winding segment is coupled with the second main winding segment.

Optionally, the coupled winding combination comprises at least two symmetrically arranged auxiliary windings.

Optionally, the auxiliary winding, the first main winding segment and the second main winding segment are coplanar, and the first main winding segment and the second main winding segment are respectively located on two sides of the auxiliary winding.

Optionally, the auxiliary winding, the first main winding segment and the second main winding segment are both planar and are parallel to each other.

Optionally, a portion of the first main winding is a third main winding segment, and the third main winding segment is not coupled with the auxiliary winding; a portion of the first main winding is a fourth main winding segment, and the fourth main winding segment is not coupled with the auxiliary winding; the third main winding segment is coupled with the fourth main winding segment.

Optionally, the third main winding segment couples with the fourth main winding segment; the third main winding segment and the fourth main winding segment are arranged side by side or in parallel; and a non-magnetic material or a magnetic material with a magnetic conductivity lower than that of the magnetically permeable core is set in an interval space between the third main winding segment and the fourth main winding segment.

Optionally, further comprising at least one first air gap, the first air gap being located on one side of the at least one main winding.

Optionally, the first air gap passes through the apparatus in at least one first direction and extends to a surface of the apparatus in a second direction, and the first direction is different from the second direction;
wherein the first air gap divides the magnetically permeable core into at least two portions that are not in contact with each other.

Optionally, further comprising at least one first air gap, the first air gap being located on one side of the at least one main winding; and an interval space between the third main winding segment and the fourth main winding segment does not coincide with a position of the first air gap.

Optionally, further comprising at least one second air gap, at least one portion of the second air gap being located between the third main winding segment and the fourth main winding segment; wherein the second air gap and the first air gap together divide the magnetically permeable core into at least two portions that are not in contact with each other;
wherein a width of the second air gap is less than the first air gap.

Optionally, further comprising at least one first air gap, the first air gap being located on one side of the at least one main winding; and an interval space between the third main winding segment and the fourth main winding segment does not coincide with a position of the second air gap.

Optionally, further comprising at least one second air gap, at least one portion of the second air gap being located between the third main winding segment and the fourth main winding segment; wherein the second air gap and the first air gap together divide the magnetically permeable core into at least two portions that are not in contact with each other; wherein a width of the second air gap is less than the first air gap.

Optionally, the main winding is Z-shaped;
wherein the magnetically permeable core and the coupled winding combination are integrally formed by pressing.

In general, another aspect features a voltage regulator module, comprising:
at least one two-phase voltage regulator module, wherein the two-phase voltage regulator module comprises:
an apparatus of claim 1, wherein the number of main windings included in the apparatus is two, the number of auxiliary windings included in the apparatus is two, and the two auxiliary windings are respectively a first auxiliary winding and a second auxiliary winding;
a mainboard device group, wherein the mainboard device group comprises a top plate, and a switch device, an input capacitor and an auxiliary winding top pad disposed on the top plate;
a bottom plate, wherein the bottom plate comprises a power input pad, a power output pad, a first auxiliary winding external connection pad, a second auxiliary winding external connection pad, and an auxiliary winding bottom electrical connector;
a vertical electrical connector wherein the vertical electrical connector comprises a vertical power electrical connector, a first vertical auxiliary winding electrical connector and a second vertical auxiliary winding electrical connector, wherein two ends of the vertical electrical connector are respectively disposed on the first surface and the second surface of the apparatus;
wherein the mainboard device group is disposed on the first surface of the apparatus; the main winding is electrically connected to the corresponding switch device through a pad disposed on the first surface; the vertical power electrical connector is electrically connected to the switch device through the top plate; the first vertical auxiliary winding electrical connector is electrically connected to one end of the first auxiliary winding on the first surface through the top plate, and the second vertical auxiliary winding electrical connector is electrically connected to one end of the second auxiliary winding on the first surface through the top plate;
wherein the apparatus is electrically connected to the bottom plate through the second contact surface; one end of the main winding on the second surface is electrically connected to the corresponding output pad; the vertical power electrical connector is electrically connected to the power input pad; one end of the first auxiliary winding on the second surface is electrically connected to the first auxiliary winding external connection pad; one end of the second auxiliary winding on the second surface is electrically connected to the first vertical auxiliary winding electrical connector through the auxiliary winding bottom electrical connector; the second vertical auxiliary winding electrical connector is electrically connected to the second auxiliary winding external connection pad.

Optionally, further comprising a load mainboard and at least two two-phase voltage regulator modules, wherein the power input pads and the power output pads of the two-phase voltage regulator modules are electrically connected in parallel through the load mainboard; the first auxiliary winding external connection pads and the second auxiliary winding external connection pads of etch of the two-phase voltage regulator modules are connected in series through the load mainboard to form an auxiliary winding loop.

Optionally, the coupling coefficient of the main winding and the corresponding auxiliary winding is greater than 0.85; the multi-phase voltage regulator module further comprises an externally connected compensation inductor, and the compensation inductor is connected in series in the auxiliary winding loop.

The details of one or more embodiments of the invention are set forth in the accompanying drawings and description below. Other features, objects, and advantages of the invention will be apparent from the description and drawings, and from the claims.

### BRIEF DESCRIPTION OF THE DRAWINGS

FIG. 1A and FIG. 1B are schematic circuit diagrams of the TLVR technology in the prior art.

FIG. 2A and FIG. 2B are schematic diagrams of a multi-phase circuit of the TLVR technology in the prior art.

FIG. 3A to FIG. 3D are schematic diagrams of the embodiment 1 of this application.

FIG. 4A to FIG. 4B are schematic diagrams of the embodiment 2 of this application.

FIG. 5A to FIG. 5B are schematic diagrams of the embodiment 3 of this application.

FIG. 6A to FIG. 6B are schematic diagrams of the embodiment 4 of this application.

FIG. 7 is a schematic diagram of the embodiment 5 of this application.

FIG. 8A to FIG. 8E are schematic diagrams of the embodiment 6 of this application.

FIG. 9 is a schematic diagram of the embodiment 7 of this application.

FIG. 10A to FIG. 10C are schematic diagrams of the embodiment 8 of this application.

FIG. 11 is a schematic diagram of the embodiment 9 of this application.

FIG. 12A to FIG. 12D are schematic diagrams of the embodiment 10 of this application.

FIG. 13A to FIG. 13F are schematic diagrams of the embodiment 11 of this application.

FIG. 14A to FIG. 14C are schematic diagrams of the embodiment 12 of this application.

FIG. 15A to FIG. 15E are schematic diagrams of the embodiment 13 of this application.

FIG. 16A to FIG. 16E are schematic diagrams of the embodiment 14 of this application.

FIG. 17A to FIG. 17C are schematic diagrams of the embodiment 15 of this application.

FIG. 18A to FIG. 18B are schematic diagrams of the embodiment 16 of this application.

FIG. 19A to FIG. 19B are schematic diagrams of the embodiment 17 of this application.

FIG. 20A to FIG. 20D are schematic diagrams of the embodiment 18 of this application.

### DESCRIPTION OF THE EMBODIMENTS

The present application discloses various embodiments or examples of implementing the thematic technological schemes mentioned. To simplify the disclosure, specific instances of each element and arrangement are described below. However, these are merely examples and do not limit the scope of protection of this invention. For instance, a first feature recorded subsequently in the specification formed above or on top of a second feature may include an embodiment where the first and second features are formed through direct contact, or it may include an embodiment where additional features are formed between the first and second features, allowing the first and second features not to be directly connected. Additionally, these disclosures may repeat reference numerals and/or letters in different examples. This repetition is for brevity and clarity and does not imply a relationship between the discussed embodiments and/or structures. Furthermore, when a first element is described as being connected or combined with a second element, this includes embodiments where the first and second elements are directly connected or combined with each other, as well as embodiments where one or more intervening elements are introduced to indirectly connect or combine the first and second elements.

The object of this application is to provide an inductor structure in the TLVR technology, so that the multi-phase inductor has a coupled characteristic through the TLVR technology, so that the voltage regulator module (VRM) achieves better dynamic performance, and the switch device on the top surface is closer to the radiator, so that the heat dissipation capability of the VRM is enhanced, and the power density of the VRM is improved.

Another object of this application is to provide a multi-phase voltage regulator module using the above inductor structure.

The technical solutions in the embodiments of the present disclosure will be clearly and completely described below with reference to the accompanying drawings in the embodiments of the present disclosure. All other embodiments obtained by a person of ordinary skill in the art based on the embodiments of the present disclosure without creative efforts shall fall within the protection scope of the present disclosure.

### Embodiment 1

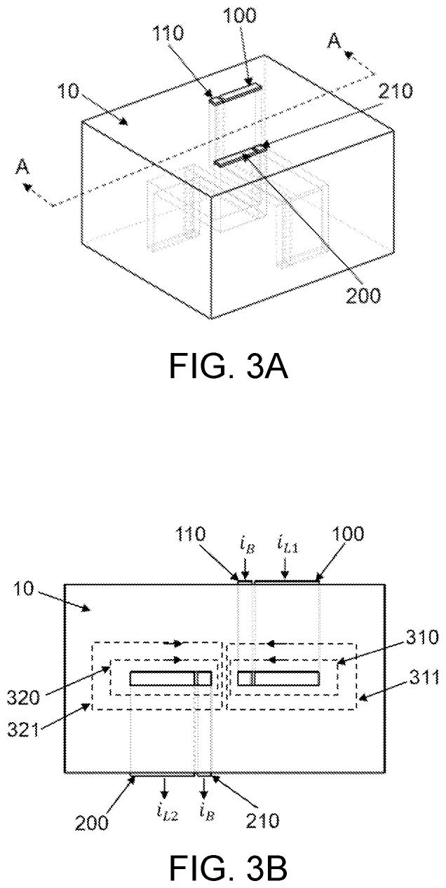

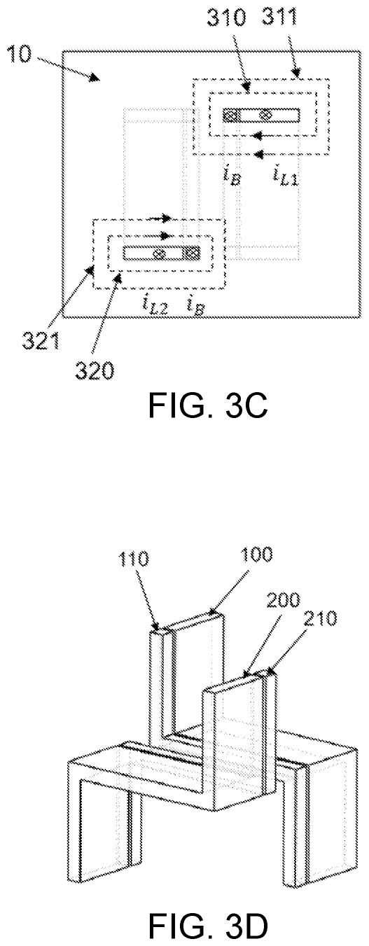

FIG. 3A is a schematic structural diagram of the present embodiment. FIG. 3B is a cross-sectional view of section A-A in FIG. 3A. FIG. 3C is a top view. As shown in FIG. 3A, the present embodiment includes a magnetically permeable core 10, a first main winding 100, a first auxiliary winding 110, a second main winding 200 and a second auxiliary winding 210, wherein a plane where a top surface of the magnetically permeable core is located is a first surface, a plane where the bottom surface is located is a second surface. The current direction shown in FIG. 3C is a direction from the first surface to the second surface. The first main winding 100 and the first auxiliary winding 110 form a first phase inductor. The second main winding 200 and the second auxiliary winding 210 form a second phase inductor. A magnetic material is provided between the first phase inductor and the second phase inductor. As shown in FIG. 3B and FIG. 3C, the magnetic flux 310 generated by the current in the first main winding 100 and the magnetic flux 320 generated by the current in the second main winding 200 are decoupled by the magnetic material between the two-phase inductors, so that the first phase inductor and the second phase inductor are two mutually independent phase inductors. That is, the first main winding 100 and the second main winding 200 are not coupled with each other. That is, the coupling coefficient between the first main winding 100 and the second main winding 200 is close to 0. Generally, the coupling coefficient between the two-phase windings is less than 0.2, and it is considered that the two-phase windings are not coupled.

FIG. 3D shows a schematic structural diagram of the winding. A magnetically conductive magnetic material is not provided between the first main winding 100 and the first auxiliary winding 110, and the first main winding 100 and the first auxiliary winding 110 have the same thickness and trend, but only have different widths. The magnetic flux 310 of the first main winding 100 and the magnetic flux 311 of the first auxiliary winding 110 are coupled together, so that there is a strong coupling between the first main winding 100 and the first auxiliary winding 110. The second main winding 200 and the second auxiliary winding 210 constitute a spatial position relationship similar to the first phase inductor. As shown in FIG. 3D, the magnetic flux 320 of the second main winding 200 and the magnetic flux 321 of the second auxiliary winding 210 are coupled together, and strong coupling is also provided between the second main winding 200 and the second auxiliary winding 210. That is, the coupling coefficient between the first main winding 100 and the first auxiliary winding 110 and between the second main winding 200 and the second auxiliary winding 210 is large. Generally, the coupling coefficient between the two-phase windings is greater than 0.85, and it is considered that the two-phase windings are strongly coupled.

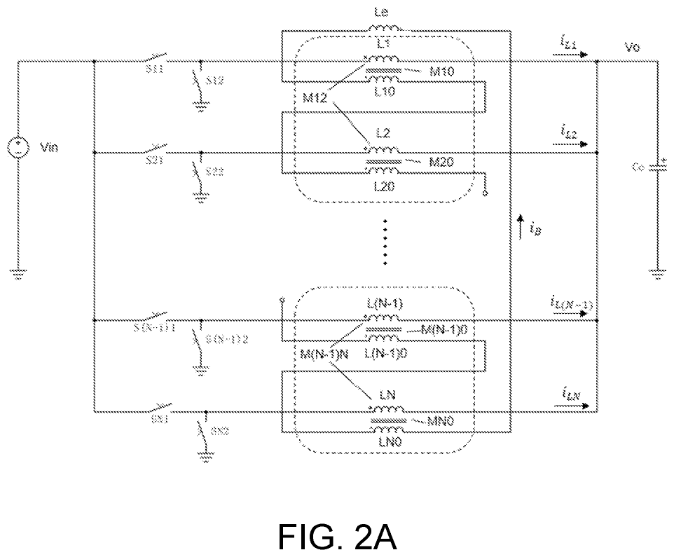

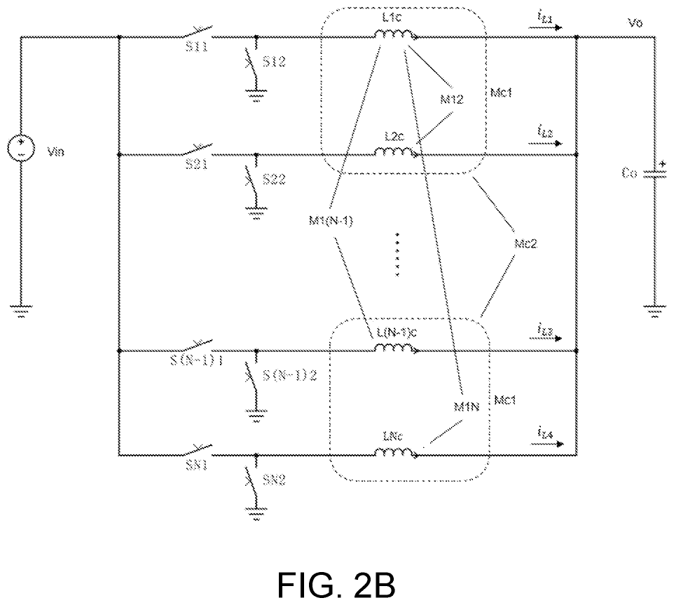

For the N-phase inductor (N is an even number), when the N/2 two-phase inductors shown in FIG. 3A are connected according to the schematic diagram shown in FIG. 2A, and the compensation inductor Le is externally connected, the equivalent N-phase coupled mutually anti-coupled inductor shown in FIG. 2B can be implemented to meet the requirements of VRM on dynamic performance and steady-state efficiency.

### Embodiment 2

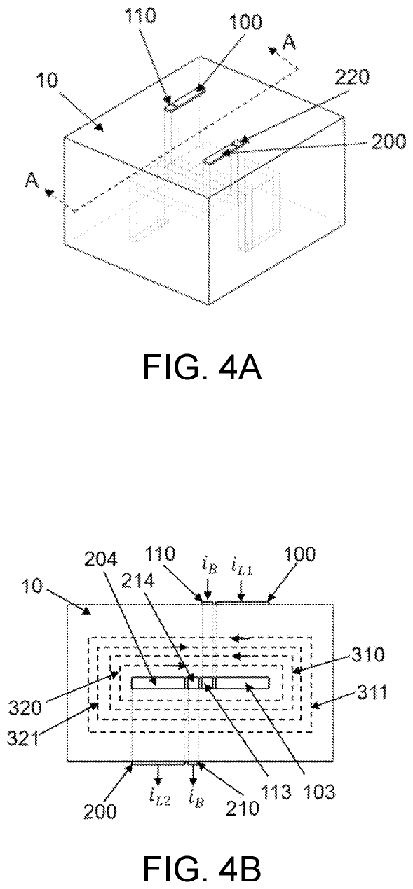

FIG. 4A is a schematic structural diagram of the present embodiment. FIG. 4B is a cross-sectional view of section A-A in FIG. 4A. The difference between this embodiment and the first embodiment is that there is no magnetically conductive magnetic material between some of the conductors in the present embodiment, wherein some of the conductors are some conductors of the winding in the first phase inductor and the winding in the second phase inductor. Therefore, the main winding of the first phase inductor has a certain degree of coupled relationship with the main winding of the second phase inductor. As shown in FIG. 4B, the middle portion of the first main winding 100 and the middle portion of the second main winding 200 (that is, the third main winding segment 103, the third auxiliary winding segment 113, the fourth main winding segment 204, and the fourth auxiliary winding segment 214) are arranged side by side or in parallel, there is no magnetically conductive magnetic material therebetween. The current direction in the third main winding segment 103 is opposite to the current direction in the fourth main winding segment 204. The magnetic flux 310 generated by the first main winding 100 and the magnetic flux 320 generated by the second main winding 200 are opposite in direction, the magnetic flux 310 and the magnetic flux 320 cancel each other. Therefore, the first main winding 100 and the second main winding 200 form a two-phase anti-coupled inductor.

In this embodiment, the first auxiliary winding 110 and the second auxiliary winding 210 are disposed between the first main winding 100 and the second main winding 200.

### Embodiment 3

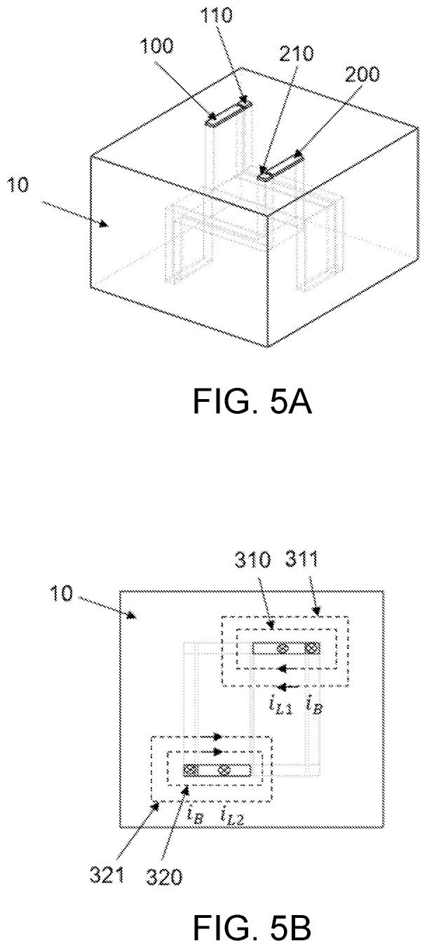

FIG. 5A is a schematic structural diagram of the present embodiment. FIG. 5B is a top view. The difference between this embodiment and the second embodiment is that the positions of the main winding and the auxiliary winding in this embodiment are different. The first main winding 100 and the second main winding 200 in this embodiment are respectively disposed between the first auxiliary winding 110 and the second auxiliary winding 210. The purpose of this arrangement is that the first main winding 100 is closer to the second main winding 200, and the coupling between the first main winding 100 and the second main winding 200 is stronger, so as to obtain a smaller leakage inductance to improve the dynamic performance of the VRM. The main winding and the auxiliary winding in the present embodiment are also strongly coupled, and an external compensation inductor Le is also required to implement the TLVR technology.

### Embodiment 4

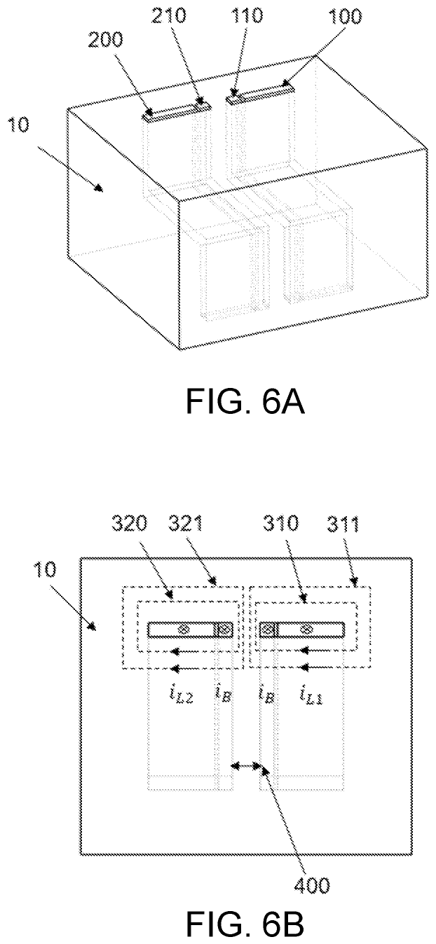

FIG. 6A is a schematic structural diagram of the present embodiment. FIG. 6B is a top view. The difference between this embodiment and the first embodiment is that in this embodiment the position where the winding of the first phase inductor exposes the pin on the top surface and the position where the winding of the second phase inductor exposes the pin on the top surface is disposed at the same side, the winding of the first phase inductor exposes the pin on the bottom surface and the position where the winding of the second phase inductor exposes the pin on the bottom surface is disposed at the other same side. In this way, the advantage of setting the position of the winding to expose the pin is that the performance of the two-phase VRM composed of the two-phase inductor is more balanced. As shown in FIG. 6B, a magnetically conductive magnetic material is provided between the main windings of the two-phase inductor in this embodiment, so that the main windings of the two-phase inductor are not coupled with each other, the main winding and the auxiliary winding in the present embodiment are also strongly coupled, and an external compensation inductor Le is also required to implement the TLVR technology.

### Embodiment 5

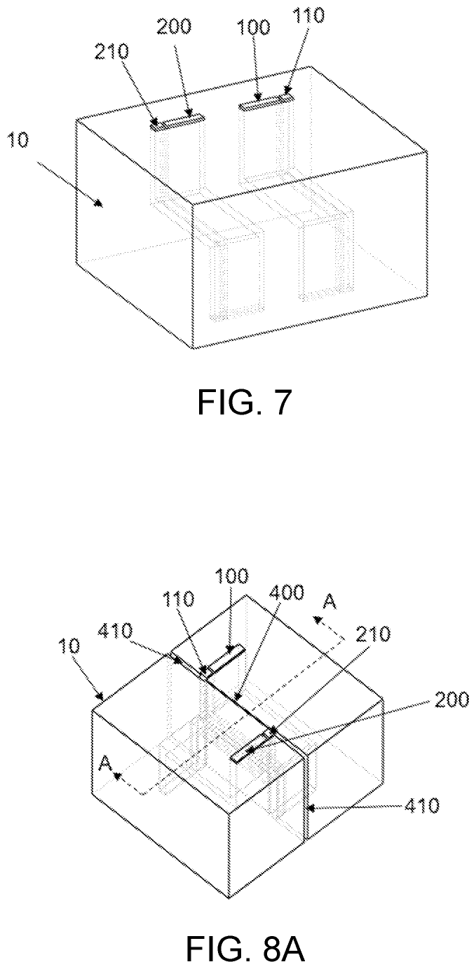

FIG. 7 is a schematic structural diagram of this embodiment. The difference between this embodiment and the fourth embodiment is that the relative positions of the main winding and the auxiliary winding in this embodiment are different. In this embodiment the first main winding 100 and the second main winding 200 are disposed between the first auxiliary winding 110 and the second auxiliary winding 210. The purpose of this arrangement is to enable the VRM to meet different requirements of different applications on pinouts. A magnetically conductive magnetic material is provided between the windings of the two-phase inductor in this embodiment, so that the main windings of the two-phase inductor are not coupled with each other. The main winding and the auxiliary winding in the present embodiment are also strongly coupled, and an external compensation inductor Le is also required to implement the TLVR technology.

### Embodiment 6

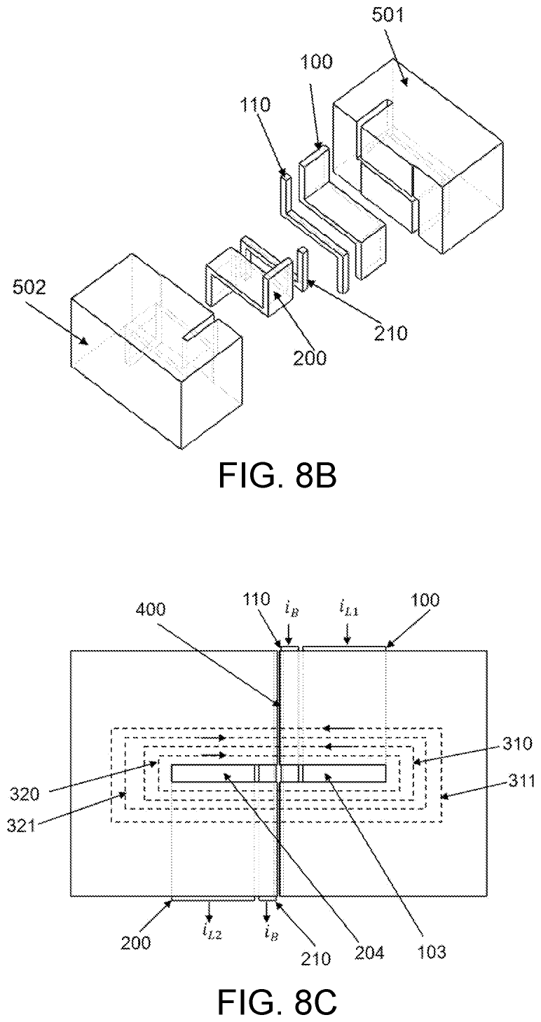

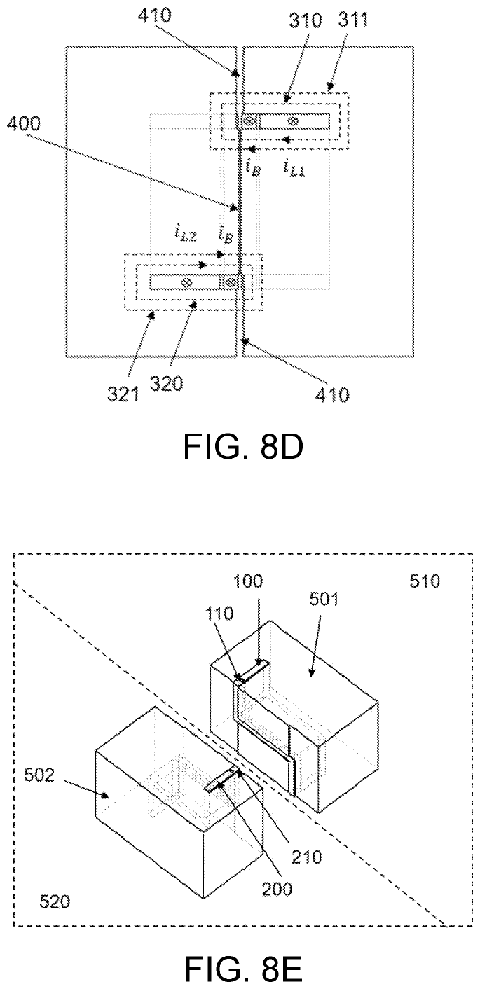

FIG. 8A is a schematic structural diagram of the present embodiment. FIG. 8B is an exploded view of FIG. 8A. FIG. 8C is a cross-sectional view of section A-A in FIG. 8A, and FIG. 8D is a top view. The structure and technical effect of the present embodiment are the same as the structure and technical effect in the first embodiment, and the difference lies in that the magnetic material and winding may be integrally formed by pressing or may be formed by assembling in this embodiment. An air gap is provided on the magnetic flux path in the magnetic material for adjusting the inductance, such as the first air gap 410 and the second air gap 400. As shown in FIG. 8C, the magnetic flux 310 and the magnetic flux 320 generated by the third main winding segment 103 and the fourth main winding segment 204 are mutually coupled in the middle portion of the winding, and because the current flow directions of the middle portions of the two main windings are opposite, the magnetic flux generated by the current in the middle portion is counteracted, and the two main windings form an anti-coupled relationship. The magnetic fluxes 310 and 320 generated in the middle portion of the current in the two main windings pass through the second air gap 400. Therefore, the second air gap may be used to adjust the strength of the coupling between the first main winding 100 and the second main winding 200. Thus, when the size of the second air gap 400 is reduced, the coupling between the first main winding 100 and the second main winding 200 is enhanced. When the size of the second air gap 400 is increased, the coupling between the first main winding 100 and the second main winding 200 is weakened. As shown in FIG. 8D, the portion of the two main windings close to the top surface or close to the bottom surface is disposed at a diagonal position. The width of the second air gap 400 between the two main windings is smaller than that of the first air gaps 410 on the two sides of the winding. That is, the magnetic resistance between the two main windings is smaller than that of the two sides of the two main windings, that means the magnetic flux 310 and the magnetic flux 320 generated by the current in the two main windings near a portion of the top surface or a portion close to the bottom surface are not coupled. The non-coupled magnetic flux generates a leakage inductance, that means the first air gap 410 is used for adjusting the leakage inductance magnitude between the two main windings.

There is no magnetic material disposed between the first main winding 100 and the first auxiliary winding 110 and between the second main winding 200 and the second auxiliary winding 210 in this embodiment. Therefore, there is a strong coupled relationship between the main winding and the corresponding auxiliary winding, and an external compensation inductor Le is also required to implement the TLVR technology.

Because the coupling and leakage inductance between the two-phase main windings in this embodiment can be adjusted by the first air gap 410 and the second air gap 400, the equivalent N-phase anti-coupled inductor can be adjusted more flexibly through the sizes of the first air gap 410 and the second air gap 400 and the external compensation inductance Le to meet the requirements of more applications on transient response speed and steady-state efficiency.

FIG. 8E is a possible manufacturing method of the present embodiment, that means the first main winding 100, the first auxiliary winding 110 and the first magnetically permeable core 501 are integrally formed into a first inductor 510. The second main winding 200, the second auxiliary winding 210, and the second magnetically permeable core 502 are integrally formed into a second inductor 520, and the first inductor 510 and the second inductor 520 are assembled together to form the two-phase inductor shown in FIG. 8A.

### Embodiment 7

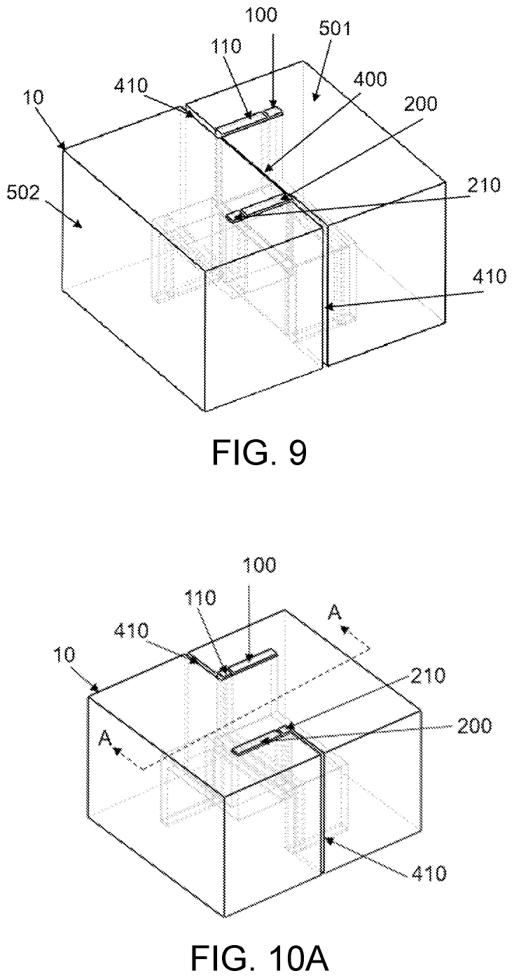

FIG. 9 is a schematic structural diagram of the present embodiment, and the technical effects of the present embodiment and the sixth embodiment are the same. The difference between this embodiment and the sixth embodiment is that the first main winding 100 and the second main winding 200 in the present embodiment are disposed between the first auxiliary winding 110 and the second auxiliary winding 210, so that the first main winding 100 is closer to the second main winding 200, then the coupling between the first main winding 100 and the second main winding 200 is better. Therefore, the VRM has better dynamic performance, and to meet different requirements of different applications on pinouts. The VRM can be used in more applications.

### Embodiment 8

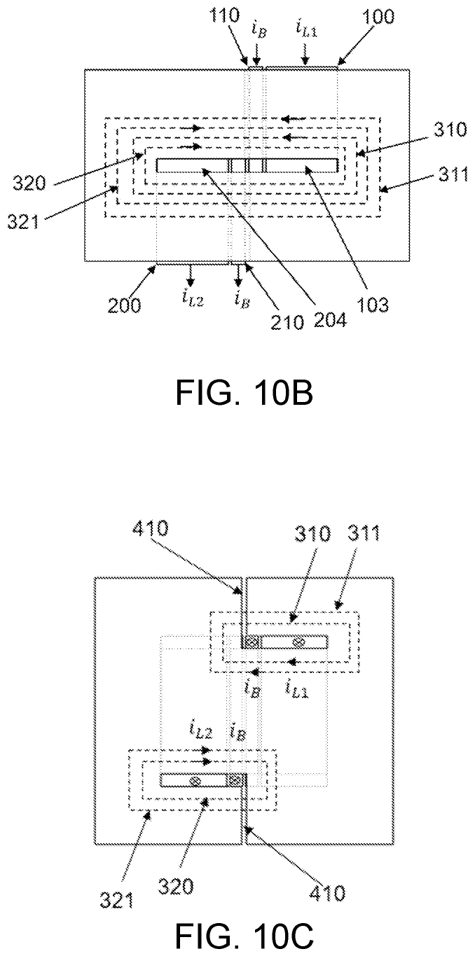

FIG. 10A is a schematic structural diagram of the present embodiment. FIG. 10B is a cross-sectional view of section A-A in FIG. 10A. FIG. 10C is a top view. The technical effects of the present embodiment and the sixth embodiment are the same. The difference between this embodiment and the sixth embodiment is that there is only a first air gap 410 provided in the present embodiment, but no second air gap 400 is provided. As shown in FIG. 10B and FIG. 10C, the magnetic flux generated by the current in the first main winding 100 and the second main winding 200 in the middle of the winding (that is, the third main winding segment 103 and the fourth main winding segment 204) is coupled with each other. Since no second air gap 400 is provided, the magnetic flux generated by the first main winding 100 and the second main winding 200 in the middle portion does not pass through the air gap with high magnetic resistance, so that the coupling is better. The leakage inductance is smaller. The presence of the first air gap 410 in the flux leakage path may further adjust the leakage inductance to obtain a smaller leakage inductance. Therefore, the VRM module has a faster transient response speed.

Since the second air gap 400 is not provided in this embodiment, a preferred arrangement direction of the first air gap 410 is shown more clearly, the first air gap 410 passes through the inductor structure 3 in a first direction and extends along a second direction to a surface of the inductor structure 3. In this embodiment, the first direction is a direction perpendicular to the first surface and the second surface, the second direction is a direction parallel to the arrangement direction of the winding, and the second direction is a direction perpendicular to the first direction, that is, two symmetrically arranged half-cut notch-shaped air gaps are formed.

### Embodiment 9

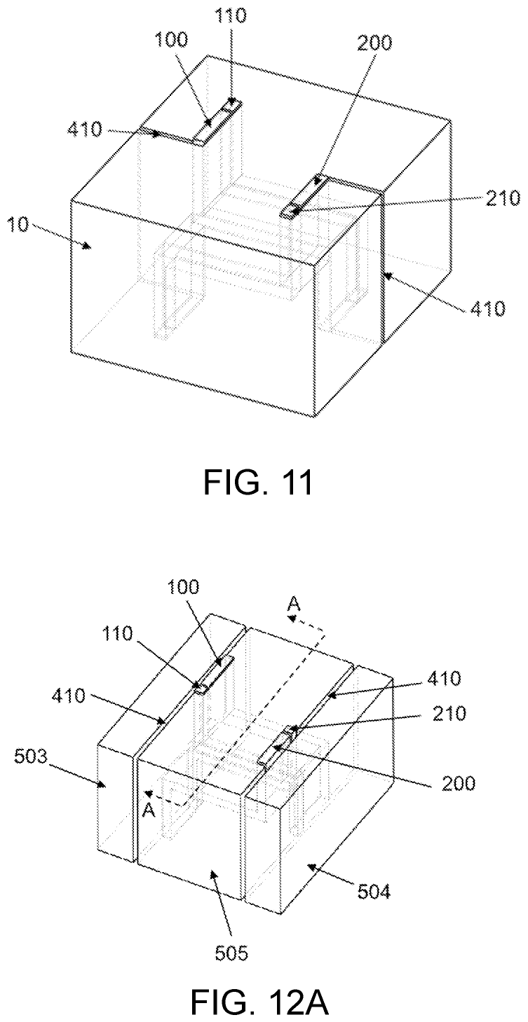

FIG. 11 is a schematic structural diagram of the present embodiment. The technical effects of the present embodiment and the eighth embodiment are the same. The difference between this embodiment and the eighth embodiment is that the first main winding 100 and the second main winding 200 in the present embodiment are disposed between the first auxiliary winding 110 and the second auxiliary winding 210. The purpose of this arrangement is that the first main winding 100 is closer to the second main winding 200, then the coupling between the first main winding 100 and the second main winding 200 is better. Therefore, the VRM has better dynamic performance. Meanwhile, to meet different requirements of different applications on pinouts, the VRM can be used in more applications.

### Embodiment 10

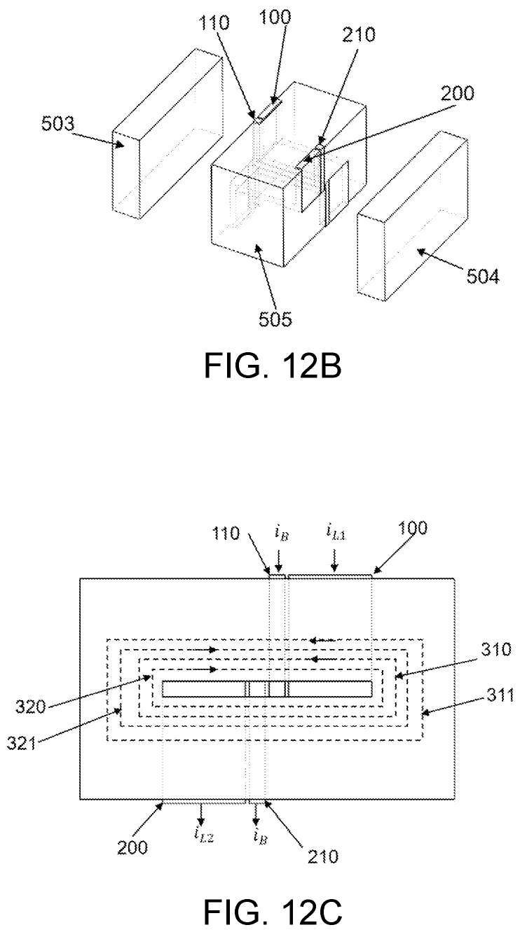

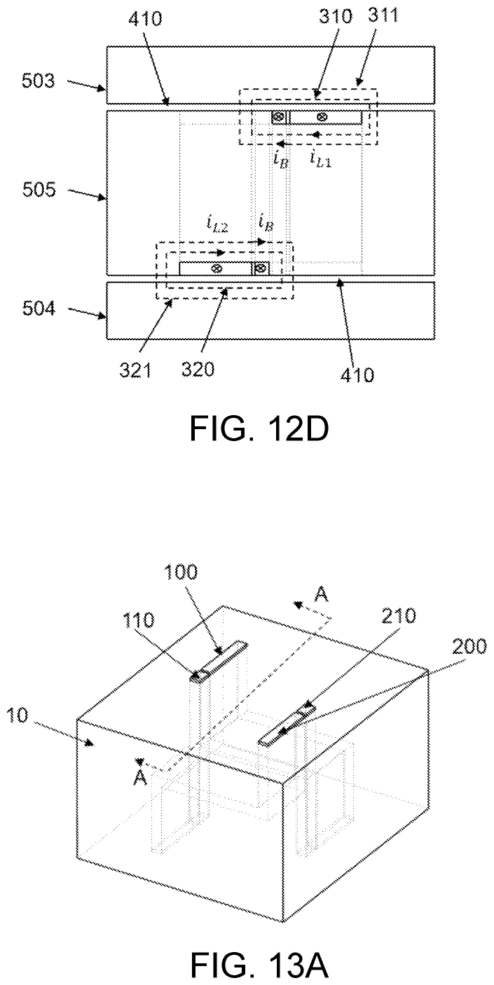

FIG. 12A is a schematic structural diagram of the present embodiment. FIG. 12B is an exploded view of FIG. 12A. FIG. 12C is a cross-sectional view of section A-A in FIG. 12A. FIG. 12D is a top view. As shown in FIG. 12A, the present embodiment includes a third magnetically permeable core 503, a fourth magnetically permeable core 504, a fifth magnetically permeable core 505, a first main winding 100, a first auxiliary winding 110, a second main winding 200, a second auxiliary winding 210, and a first air gap 410. The present embodiment has the same technical effect as that generated in Embodiment 8. The difference between this embodiment and the eighth embodiment is that the position, size and mode of the arrangement of the first air gap 410 in this embodiment are different. As shown in FIG. 12B, the inductor in this embodiment may be considered to comprise a third magnetically permeable core 503, a fourth magnetically permeable core 504, and a first component comprising a fifth magnetically permeable core 505, a first main winding 100, a first auxiliary winding 110, a second main winding 200, and a second auxiliary winding 210. A first air gap 410 is provided between the third magnetically permeable core 503 and the first component and between the fourth magnetically permeable core 504 and the first component. As shown in FIG. 12C, the magnetic flux generated by the current in the middle portion of the first main winding 100 and the second main winding 200 in the first component (that is, the third main winding segment 103, the fourth main winding segment 204) is coupled with each other, and since no air gap is provided, the magnetic flux generated by the middle portion of the first main winding 100 and the second main winding 200 does not pass through the air gap with high magnetic resistance, so the coupling is better, and the leakage inductance is smaller. As shown in FIG. 12D, the first air gap 410 is disposed between the third magnetically permeable core 503 and the first component, and between the fourth magnetically permeable core 504 and the first component. Therefore, the magnetic flux generated by the portion of the first winding and the second winding close to the top surface and close to the bottom surface passes through the first air gap 410 twice. Therefore, under the same leakage inductance requirement, the first air gap 410 has a small size requirement. A small air gap may reduce electromagnetic interference generated by flux leakage. The first component, the upper end portion and the lower end portion of the winding are disposed on the outer side of the fifth magnetically permeable core 505, and manufacturing may be implemented by using a conventional molding method. The third magnetically permeable core 503 and the fourth magnetically permeable core 504 are both conventional I-type magnetically permeable cores, and the two I-type magnetically permeable cores and the first component are assembled together easily. Therefore, the structure shown in this embodiment is easy to produce and manufacture.

There is no magnetic material disposed between the first main winding 100 and the first auxiliary winding 110 and between the second main winding 200 and the second auxiliary winding 210, so there is a strong coupled relationship between the main winding and the auxiliary winding, and an external compensation inductor is also required to implement the TLVR technology.

When the N/2 two-phase inductors shown in FIG. 12A are connected according to the schematic diagram shown in FIG. 2A, and the compensation inductor Le is externally connected, the equivalent N-phase anti-coupled inductor shown in FIG. 2B can be implemented to meet the requirements of VRM on dynamic performance and steady-state efficiency.

### Embodiment 11

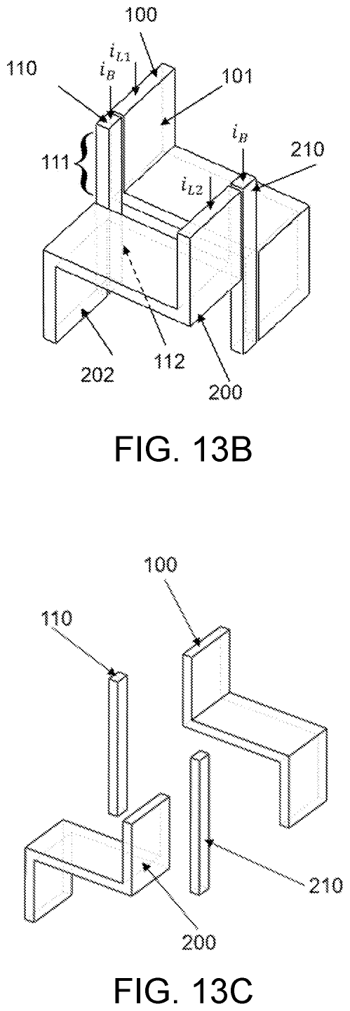

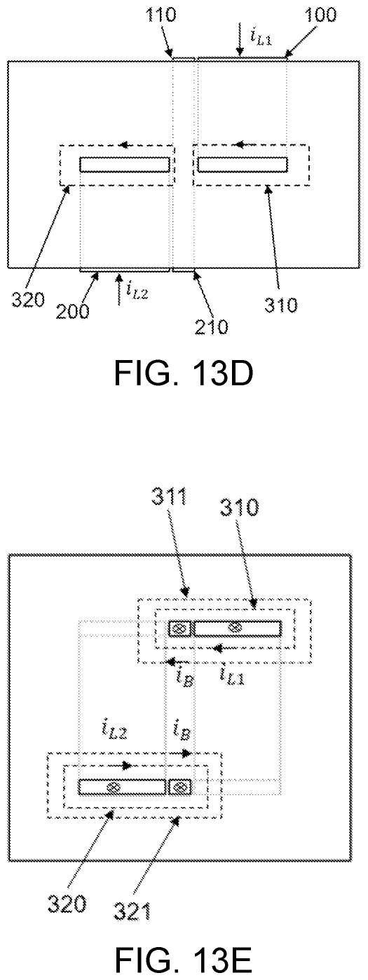

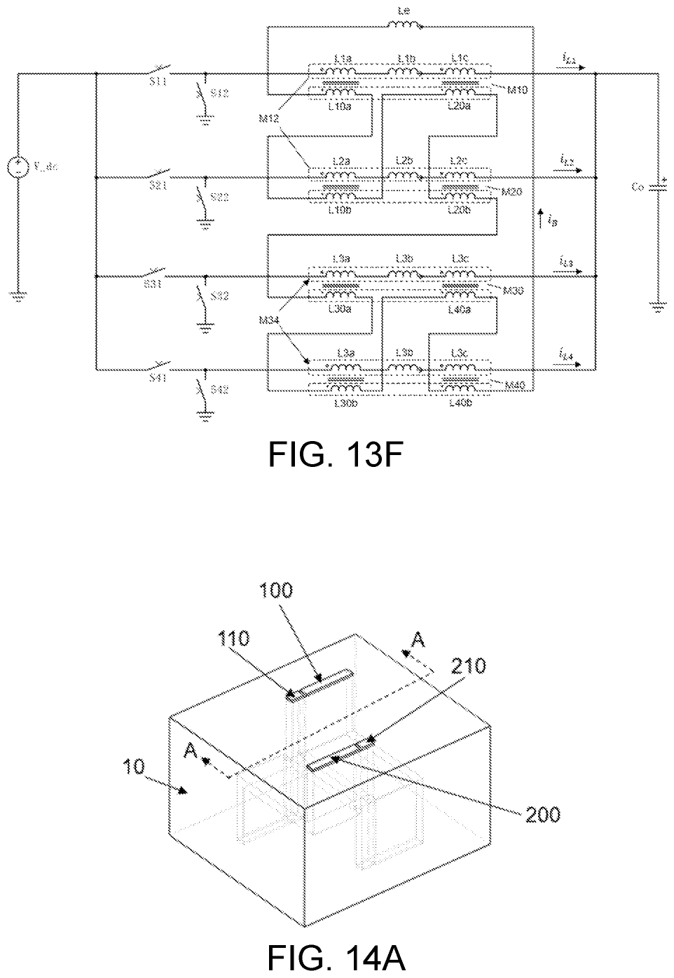

FIG. 13A is a schematic structural diagram of the present embodiment. FIG. 13B is a schematic structural diagram of windings. FIG. 13C is an exploded view of the windings. FIG. 13D is a cross-sectional view of A-A in FIG. 13A, and FIG. 13E is a top view. As shown in FIG. 13A to FIG. 13C, the present embodiment comprises a magnetically permeable core 10, a first main winding 100, a first auxiliary winding 110, a second main winding 200, and a second auxiliary winding 210; The difference between this embodiment and Embodiment 1 is that the relative positions of the main winding and the auxiliary winding are different, so that the coupling between the main winding and the auxiliary winding is different. The first auxiliary winding 110 and the upper half portion of the first main winding 100 (that is, the first auxiliary winding segment 111 and the first main winding segment 101) and the lower half portion of the second main winding 200 (that is, the second auxiliary winding segment 112 and the second main winding segment 202) are arranged together. The current direction in the first auxiliary winding 110 is the same as the current direction in the first main winding segment 101 and the current direction in the second main winding segment 202. Thus, the first auxiliary winding 110 has a coupled relationship with the first main winding segment 101 and the second main winding segment 202. Since the first auxiliary winding 110 is coupled with the upper half portion of the first main winding 100 and is coupled with the lower half portion of the second main winding 200, the coupling between the first auxiliary winding 110 and the first main winding 100 is weak, the coupling coefficient is less than 1, the coupling between the first auxiliary winding 110 and the second main winding 200 is also weak, and the coupling coefficient is less than 1. The second auxiliary winding 210 and the first auxiliary winding 110 are arranged in a symmetrical manner. The second auxiliary winding 210 is coupled with the upper half portion of the second main winding 200 and is coupled with the lower half portion of the first main winding 100. Therefore, the coupling between the second auxiliary winding 210 and the second main winding 200 is weak, the coupling coefficient is less than 1, the coupling between the second auxiliary winding 210 and the first main winding 100 is also weak, and the coupling coefficient is less than 1. The middle portion of the first main winding 100 and the middle portion of the second main winding 200 are not coupled with the auxiliary winding, so that the coupling between the main winding and the auxiliary winding is far less than 1 (specifically, the coupling coefficient between the two windings is less than 0.2, and it can be considered that the two main windings are not coupled). If the lower half portion of the first main winding 100 is also referred to as the first main winding segment 101. Theoretically, the ratio of the total length of the first main winding segment 101 to the total length of the first main winding 100 determines the coupled strength of the first main winding 100 and the first auxiliary winding 110, the second auxiliary winding 210. The higher the ratio is, the stronger the coupling between the main winding and the auxiliary winding, otherwise the weaker the coupled. The magnetic material is arranged between the first main winding 100 and the second main winding 200, so that the first main winding 100 and the second main winding 200 are not coupled. As shown in FIG. 13D and 13E, the magnetic flux 310 generated by the current in the first main winding 100 and the magnetic flux 320 generated by the current in the second main winding 200 are decoupled by the magnetic material between the two main windings.

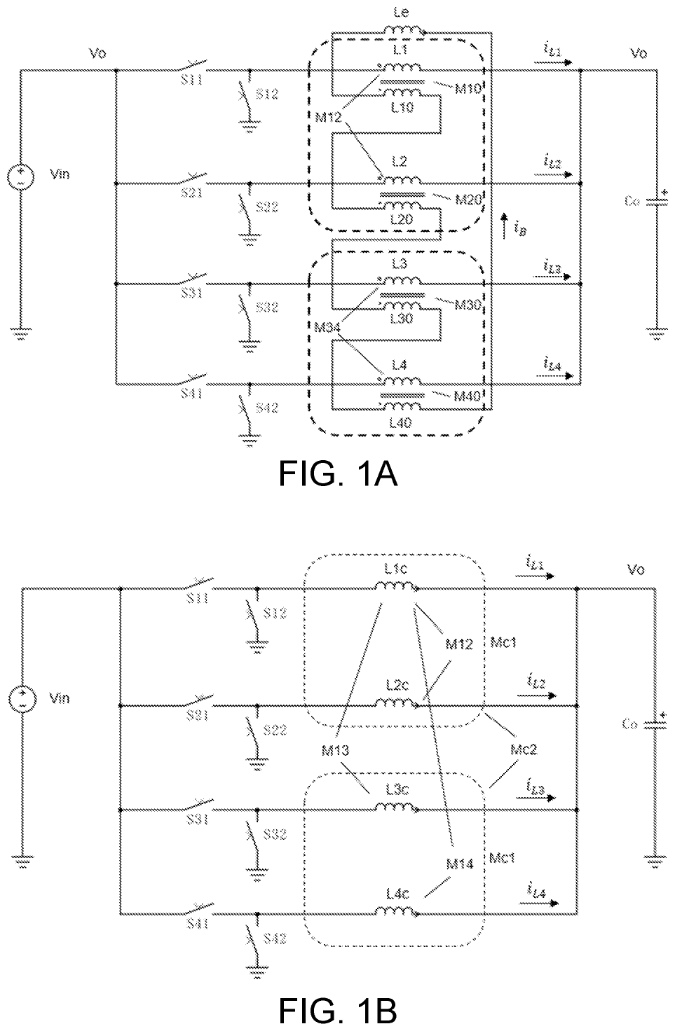

In this embodiment, the first main winding 100 is coupled with the first auxiliary winding 110 and the second auxiliary winding 210. The second main winding 200 is coupled with the first auxiliary winding 110 and the second auxiliary winding 210. Therefore, the circuit diagram of the TLVR technology implemented by the two-phase inductor in this embodiment is different from the circuit diagram of the TLVR technology implemented by the inductor in the foregoing embodiments. As shown in FIG. 13F, in this embodiment, the upper half portion of the first main winding 100 corresponds to L1a, the middle portion corresponds to L1b, and the lower half portion corresponds to L1c. The upper half portion of the second main winding 200 corresponds to L2a, the middle portion corresponds to L2b, and the lower half portion corresponds to L2c. The upper half portion of the first auxiliary winding 110 corresponds to L10a, and the lower half portion of the first auxiliary winding 110 corresponds to L10b; the upper half portion of the second auxiliary winding 210 corresponds to L20a, and the lower half portion of the second auxiliary winding 210 corresponds to L20b, and the two or more two-phase inductors are connected according to the connection mode shown in FIG. 13F, so that the multi-phase equivalent anti-coupled inductor shown in FIG. 1B or FIG. 2B may be implemented (take four phases as an example in FIG. 1B).

In this embodiment, since only a portion of the main winding has a coupled relationship with the auxiliary winding, a coupling coefficient between the main winding and the auxiliary winding is far less than 1, and usually less than 0.85. Therefore, when the TLVR technology is implemented by the two-phase inductor according to the embodiments, the compensation inductor Le can be omitted.

### Embodiment 12

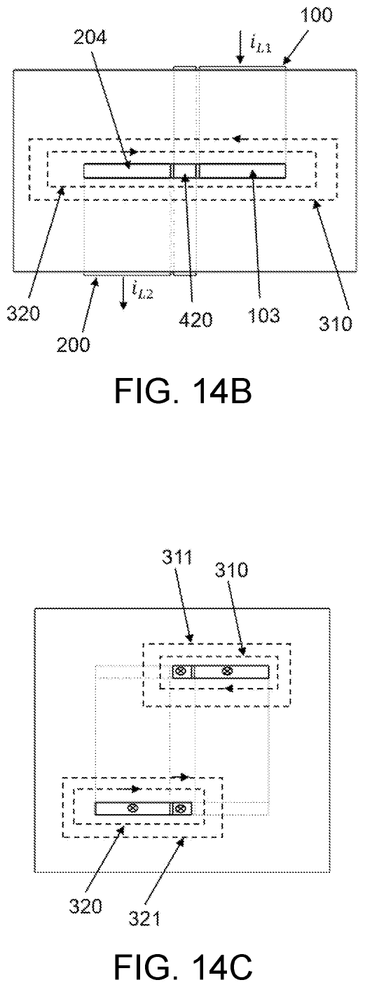

FIG. 14A is a schematic structural diagram of the present embodiment. FIG. 14B is a cross-sectional view of section A-A in FIG. 14A. FIG. 14C is a top view. The technical effects of the present embodiment and the eleventh embodiment are the same. The difference between this embodiment and the eleventh embodiment is that the middle range between the first main winding 100 and the second main winding 200 in this embodiment is not provided with a magnetic material within the range of the thickness of the windings. Therefore, the first main winding 100 and the second main winding 200 have certain coupled characteristics. As shown in FIG. 14B, the interval space 420 between the third main winding segment 103 and the fourth main winding segment 204 is set as an air gap or a non-magnetic material, so that the magnetic flux 310 generated by the current in the first main winding 100 and the magnetic flux 320 generated by the current in the second main winding 200 are coupled with each other. Because the current direction in the third main winding segment 103 and the current direction in the fourth main winding segment 204 are opposite, the directions of the magnetic flux 310 and the magnetic flux 320 are opposite, the magnetic flux 310 and the magnetic flux 320 cancel each other, so that the first main winding 100 and the second main winding 200 present anti-coupled characteristics.

### Embodiment 13

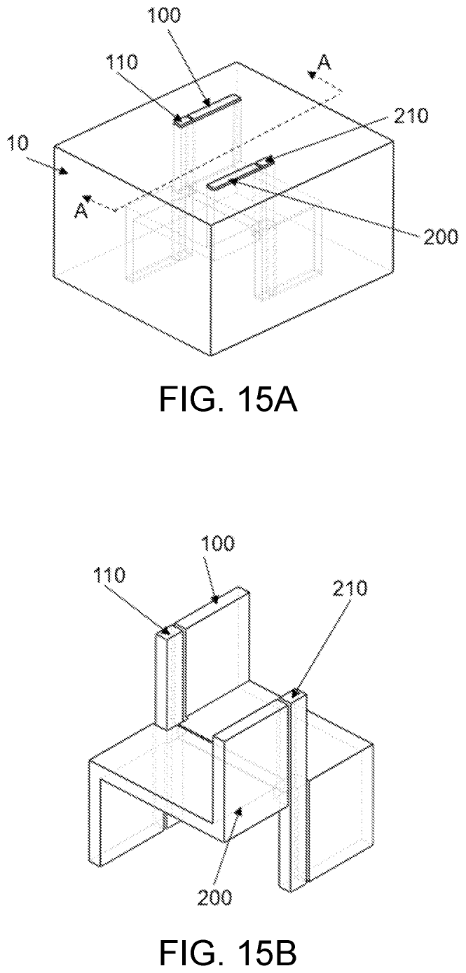

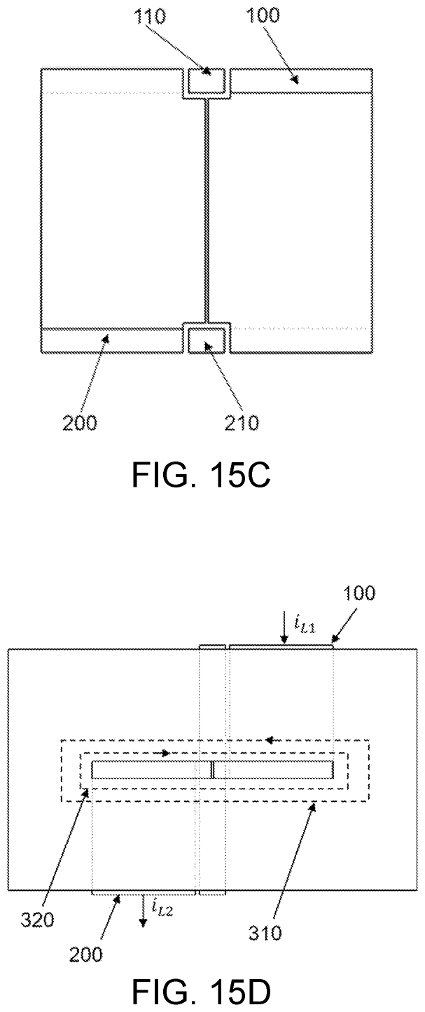

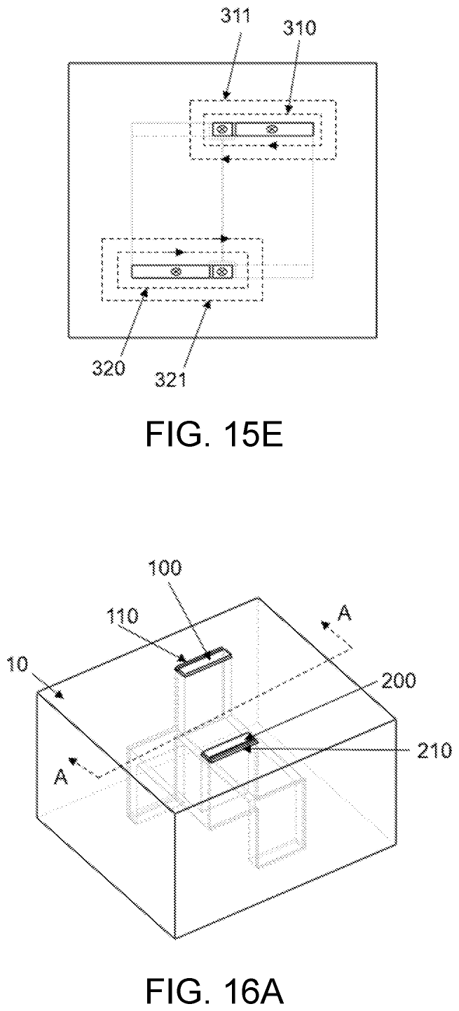

FIG. 15A is a schematic structural diagram of the present embodiment. FIG. 15B is a schematic structural diagram of a winding, and FIG. 15C is a top view of the winding structure shown in FIG. 15B. FIG. 15D is a cross-sectional view of section A-A in FIG. 15A. FIG. 15E is a top view of FIG. 15A. The technical effects generated by the present embodiment and the twelfth embodiment are the same. The difference between this embodiment and the twelfth embodiment is that in this embodiment, the shapes of the first main winding 100 and the second main winding 200 are different. As shown in FIG. 15B and FIG. 15C, the middle portions of the first main winding 100 and the second main winding 200 (that is, the third main winding segment 103 and the fourth main winding segment 204) are respectively not equal to the widths of other portions. Through the arrangement of different widths of the windings, the middle portions of the two main windings are arranged together, and magnetic materials are not arranged between the two main windings. As shown in FIG. 15D, the magnetic flux 310 generated by the current in the middle portion of the first main winding 100 and the magnetic flux 320 generated by the current in the middle portion of the second main winding 200 are mutually coupled together. Because the current direction in the third main winding segment 103 and the current direction in the fourth main winding segment 204 are opposite, the directions of the magnetic flux 310 and the magnetic flux 320 are opposite, the magnetic flux 310 and the magnetic flux 320 cancel each other, so that the first main winding 100 and the second main winding 200 are in an anti-coupled relationship.

### Embodiment 14

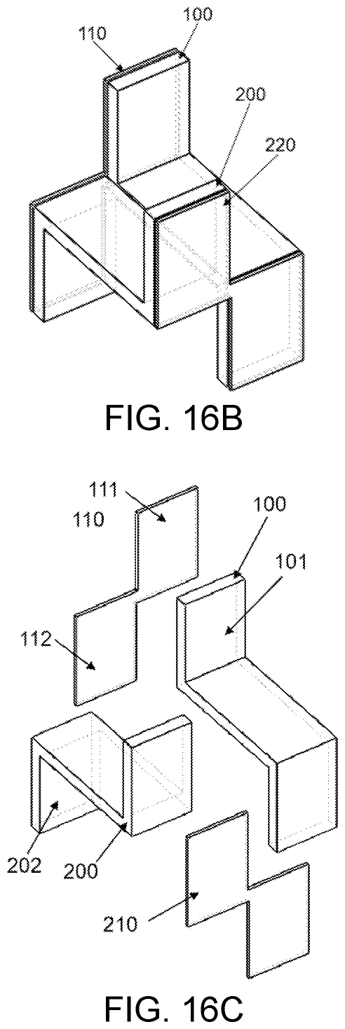

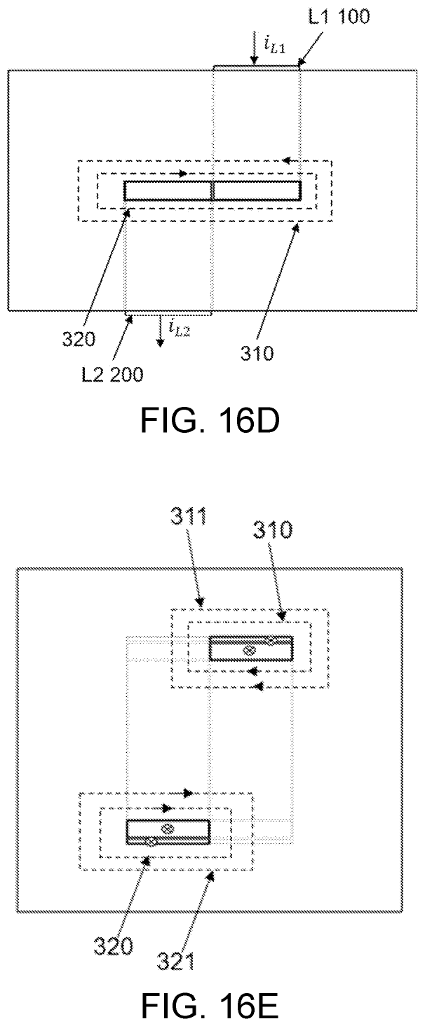

FIG. 16A is a schematic structural diagram of the present embodiment. FIG. 16B is a schematic structural diagram of a winding, and FIG. 16C is an exploded view of the winding structure shown in FIG. 16B. FIG. 16D is a cross-sectional view of section A-A in FIG. 16A. FIG. 16E is a top view of FIG. 16A. The present embodiment has the same technical effect as that generated in the twelfth embodiment. The difference between this embodiment and the twelfth embodiment is that the winding structure and the arrangement mode in this embodiment are different. As shown in FIG. 16B and FIG. 16C, the auxiliary winding in this embodiment is arranged on the side surface of the main winding, the auxiliary winding and the main winding are arranged in an overlapping manner in the thickness direction. The first auxiliary winding 110 overlaps with the first portion of the first main winding 100 (that is, the first auxiliary winding segment 111 and the first main winding segment 101) and the third portion of the second main winding 200 (that is, the second auxiliary winding segment 112 and the second main winding segment 202). The second auxiliary winding 210 overlaps with the third portion of the first main winding 100 and the first portion of the second main winding 200. The advantage of this arrangement is that the two main windings are closer to each other, and the coupled characteristic between the two main windings is better. As shown in FIG. 16D, the first main winding 100 is close to the second main winding 200, and there is no magnetic material between the two main windings, so that the coupled characteristic between the two main windings is good. Since the direction of the magnetic flux 310 is opposite to the direction of the magnetic flux 320, wherein the magnetic flux 310 and the magnetic flux 320 are generated by the current in the middle portion of the two main windings, the magnetic flux of two main windings cancel each other, and the two main windings present an anti-coupled relationship.

### Embodiment 15

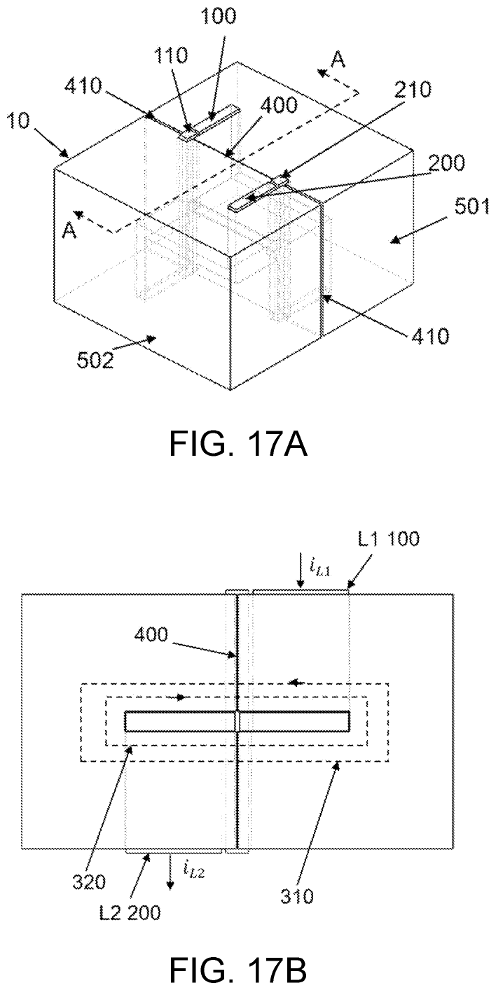

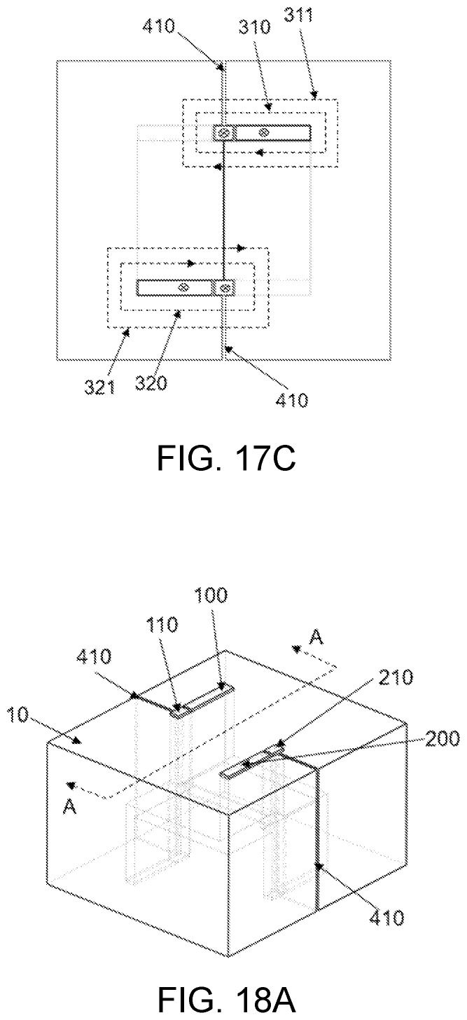

FIG. 17A is a schematic structural diagram of the present embodiment. FIG. 17B is a cross-sectional view of section A-A in FIG. 17A. FIG. 17C is a top view of FIG. 17A. The present embodiment has the same technical effect as that generated in the thirteenth embodiment. The difference between this embodiment and the third embodiment is that the magnetically permeable core in this embodiment is formed by combining the first magnetically permeable core 501 and the second magnetically permeable core 502. Therefore, the inductor in this embodiment has a first air gap 410 and a second air gap 400. As shown in FIG. 17B, the magnetic flux 310 and the magnetic flux 320 generated in the middle portion of the first winding and the second winding pass through the second air gap 400. In the foregoing embodiments, the magnetic fluxes 310 and 320 are coupled with each other and cancel each other. Therefore, the second air gap 400 may be used to adjust the coupled strength between the first winding and the second winding. As shown in FIG. 17C, the magnetic flux 310 of the first main winding 100 and the magnetic flux 311 of the first auxiliary winding 110 pass through the first air gap 410. The magnetic flux 320 of the second main winding 200 and the magnetic flux 321 of the second auxiliary winding 210 also pass through the first air gap 410 on the other side. Therefore, the first air gap 410 can be used to adjust the flux leakage of the first main winding 100 and the second main winding 200, that means the first air gap 410 and the second air gap 400 are used for adjusting coupling and leakage inductance. Therefore, the adjustment of coupling and leakage inductance may be achieved by setting the size of the first air gap 410 and the second air gap 400 in this embodiment.

### Embodiment 16

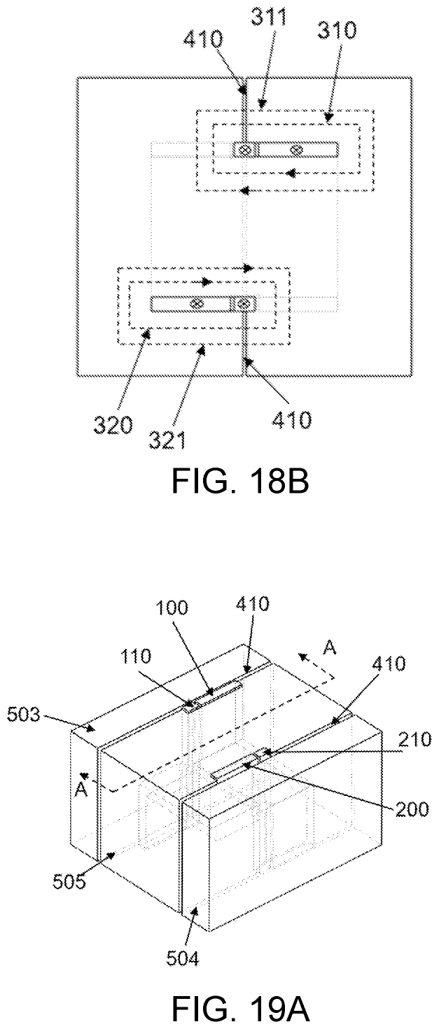

FIG. 18A is a schematic structural diagram of the present embodiment. FIG. 18B is a top view. The present embodiment has the same technical effect as that generated in embodiment 15. The difference between this embodiment and embodiment 15 is that the second air gap 400 in this embodiment is not provided. So that the coupling between the first main winding 100 and the second main winding 200 can be improved, but due to the existence of the first air gap 410, the coupling between the first main winding 100 and the second main winding 200 in this embodiment is further far less than 1, so when the two-phase inductor according to the present embodiment implements the TLVR technology according to the circuit diagram of FIG. 13F, an external compensation inductor Le may not be used.

### Embodiment 17

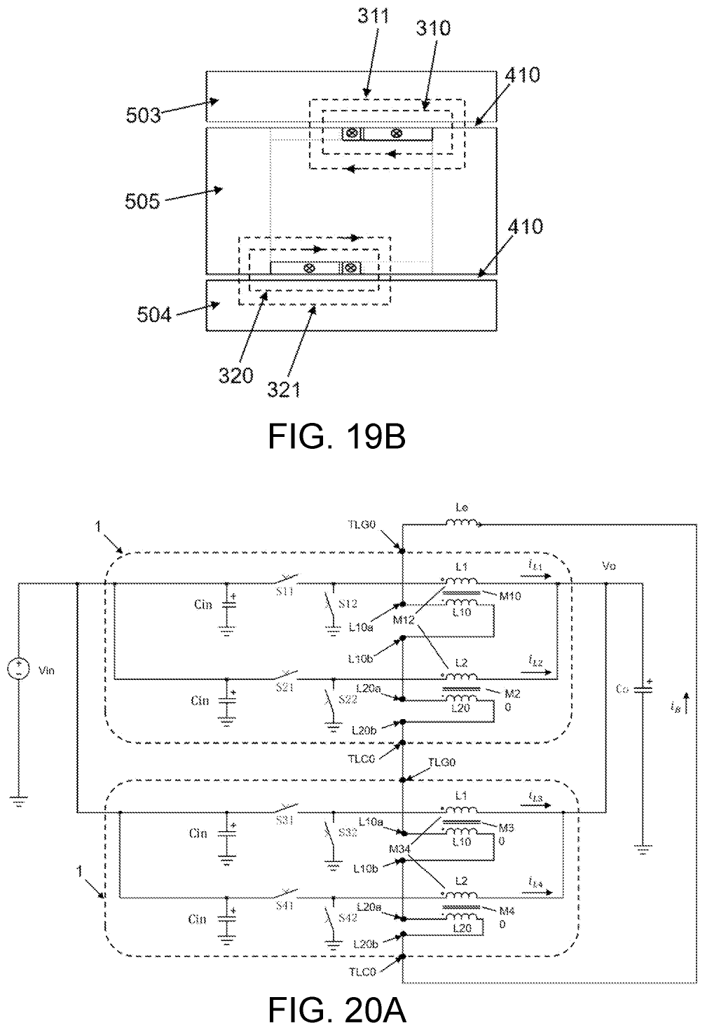

FIG. 19A is a schematic structural diagram of the present embodiment. FIG. 19B is a top view. The present embodiment has the same technical effect as that generated in embodiment 16. The difference between this embodiment and the embodiment 16 is that the direction of the first air gap 410 in this embodiment is different. The first air gap 410 in this embodiment is parallel to the width direction of the winding. The first air gap 410 divides the magnetically permeable core 10 into three portions: a third magnetically permeable core 503, a fourth magnetically permeable core 504, and a fifth magnetically permeable core 505. Wherein the fifth magnetically permeable core 505 and the winding can be integrally formed, and then assembled with the third magnetically permeable core 503 and the fourth magnetically permeable core 504, thereby reducing the manufacturing difficulty of the inductor. As shown in FIG. 19B, the magnetic flux 310 of the first main winding 100 and the magnetic flux 311 of the first auxiliary winding 110 pass through the first air gap 410 twice. The magnetic flux 320 of the second main winding 200 and the magnetic flux 321 of the second auxiliary winding 210 pass through the first air gap 410 twice. Therefore, in the case of the same leakage inductance requirement, the size of the first air gap can be much smaller, so that the interference generated by the edge magnetic flux of the air gap is reduced.

### Embodiment 18

This embodiment is a multi-phase voltage regulator module (VRM) applying the coupled inductor structure according to the foregoing embodiments, including two two-phase VRMs 1.

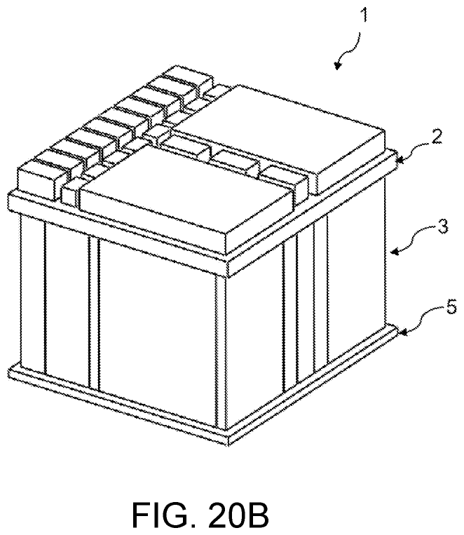

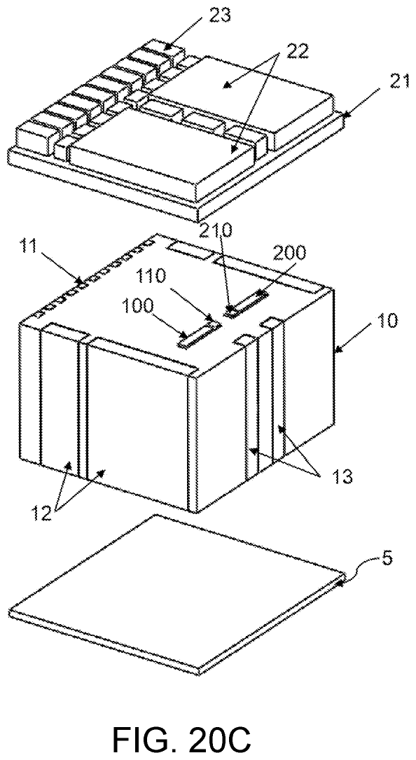

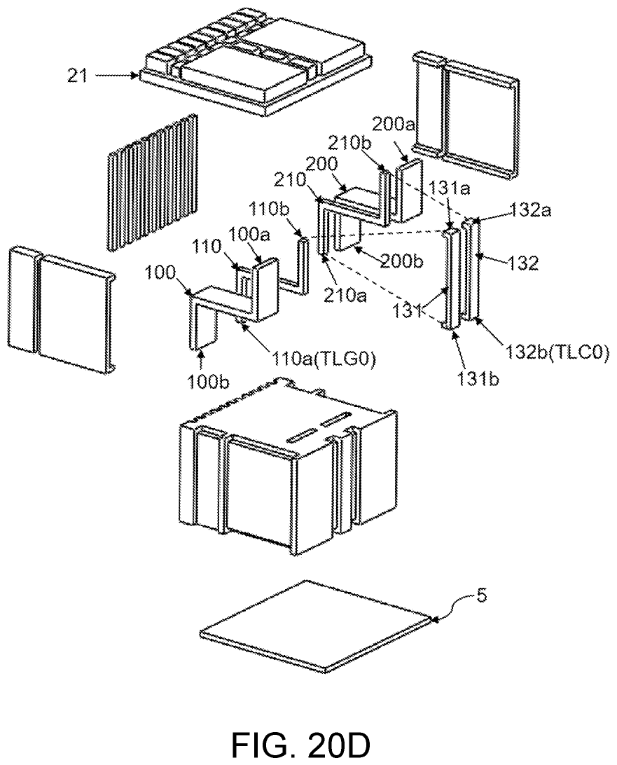

FIG. 20A is a circuit connection diagram of two two-phase VRMs implementing the TLVR technology, wherein each dashed box is shown as a two-phase VRM 1 having an auxiliary winding. TLG0 and TLC0 (that is, a first auxiliary winding external connection pad and a second auxiliary winding external connection pad) are PINs of the auxiliary winding in the VRM used to implement the TLVR function. TLG0 and TLC0 of a plurality of VRMs are connected to each other on a load mainboard, so that a TLVR technology can be implemented.

FIG. 20B shows a VRM composing the coupled inductor structure in one of the aforementioned embodiments of this invention. FIG. 20C is an exploded view of FIG. 20B. As shown in FIG. 20B and FIG. 20C, the VRM comprises a mainboard device group 2, an integrated inductor 3, and a bottom plate 5. The mainboard device group 2 includes a top plate 21, a switch device 22, an input capacitor 23, and the like. The integrated inductor 3 includes a magnetically permeable core 10, a first main winding 100, a first auxiliary winding 110, a second main winding 200, and a second auxiliary winding 210. The side surfaces of the integrated inductor 3 are respectively provided with a vertical signal electrical connector 11, a vertical power electrical connector 12, and a vertical auxiliary winding electrical connector 13. The main winding is provided with a pad on the top surface to be electrically connected to the switch device 22, and the pad is provided on the bottom surface to be electrically connected to the load. FIG. 20D is an exploded view of FIG. 20B in more detail. As shown in FIG. 20D, the first main winding 100 is provided with a pad 100a on the top surface, and the pad 100b is disposed on the bottom surface. The second main winding 200 is provided with a pad 200a on the top surface, and the pad 200b is disposed on the bottom surface. The pad 100a and the pad 200a disposed on the top surface of the first main winding and the second main winding are configured to be connected to the switch device 22. The pad 100b and the pad 200b as the output pad disposed on the bottom surface of the first main winding and the second main winding are connected to the load through the bottom plate 5. The switch device in the VRM is a main heat source, and the switch device is arranged on the top surface, so that the switch device is convenient to dissipate heat through the radiator at the top. The side power electrical connector 12 is also provided with a pad on the top surface and the bottom surface for forming a circulation path for the input current and the return current. The side signal electrical connector 11 is also provided with a pad on the top surface and the bottom surface used for transmitting signals such as driving signal, temperature signal, current detection signal. The first auxiliary winding 110 has a pad 110a and a pad 110b. The second auxiliary winding 210 has a pad 210a and a pad 210b; The first side auxiliary winding electrical connector 131 has a pad 131a and a pad 131b, the second side auxiliary winding electrical connector 132 has a pad 132a and a pad 132b. The pad 110b, the pad 131a, the pad 210b and the pad 132a are electrically connected through the top plate 21, respectively. The pad 131b is electrically connected to the pad 210a by means of the electrical connector in the bottom plate 5. The pad 110a and the pad 132b respectively serve as TLG0 and TLC0 for external connection, and the two pads are connected to the load mainboard by means of the bottom plate 5. On the load mainboard, the N/2 two-phase VRMs 1 are connected in series with the TLC0 through corresponding TLG0 (N is an even number). That means the TLC0 of the first module is connected to the TLG0 of the second module, and the TLC0 of the second module is connected to the TLG0 of the third module, and so on. The TLC0 of the last module and the TLG0 of the first module are connected to the compensation inductor Le on the load mainboard to form a closed loop, so that the N-phase DC-DC converter can be implemented by the N/2 two-phase VRMs 1 (N=4 in this embodiment). Because the TLVR technology is utilized, the N-phase inductors in the N-phase converter have anti-coupled characteristics with each other, lower dynamic inductance and higher steady-state inductance are achieved, and faster dynamic performance and higher efficiency are obtained.

Any two-phase coupled inductor structure formed by the invention concept of the present invention can use the method in this embodiment. To form the two-phase VRM 1, the two auxiliary windings are connected by an electrical connector, and two auxiliary winding external pads TLG0 and TLC0 are formed, which is used to connected in series with other two-phase VRMs 1, so as to realize a DC-DC converter having a N-phase TLVR function (N is any even number), achieving faster dynamic performance and higher efficiency. The shape and position of the electrical connector are not limited to the form in this embodiment.

When the method in this embodiment is used, reference may be made to the description in the foregoing embodiment. Depending on whether the coupling between the main winding and the auxiliary winding is strong or weak, the external compensation inductor Le is selected or omitted.

Various embodiments in the present invention are described in a progressive manner, each embodiment focuses on the difference from other embodiments, and the same or similar parts between the various embodiments refer to each other.

This application has the following beneficial effects:
(1) In this application, the main winding is connected to the switch device on the top surface, and is connected to the load on the bottom surface. That is, the TLVR technology is implemented in the inductor provided with the inductor having PAD on both sides. Better dynamic performance is achieved through the TLVR technology, and the switch device on the top surface is closer to the radiator. The heat dissipation capability of the VRM is enhanced, and the power density of the VRM is improved.
(2) Through the TLVR technology, the non-coupled multi-phase inductor in the plurality of VRM or the plurality of discrete inductors have a mutual coupled function. Therefore, the multi-phase VRM has a smaller dynamic inductance to meet the requirement of rapid change of the load current. Through the TLVR technology, the multi-phase coupled characteristic is achieved, which reduces the manufacturing difficulty of the traditional multi-phase coupled inductor.
(3) According to this application, the TLVR technology is implemented on the basis of a two-phase inductor, which not only solves the manufacturing difficulty of the traditional multi-phase coupled inductor, but also has a more flexible application mode.
(4) In this application, the coupling between the main and auxiliary windings of the two-phase inductor may be full coupling, that is, the coupling coefficient is approximately equal to 1; nor can be fully coupled, that is, the coupling coefficient is far less than 1, such as 0.2-0.8. When the main and auxiliary windings are full coupling, one compensation inductor needs to be externally connected to achieve multi-phase anti-coupled, and the compensation inductor can be used to adjust the magnitude of the coupling and dynamic sensing, and the application is flexible, and when the main and auxiliary windings are not full coupling, an external compensation inductor is not needed, thereby saving the occupied area of the client mainboard and saving the cost.

The above description of the disclosed embodiments enables those skilled in the art to implement or use this application. Various modifications to these embodiments will be apparent to those skilled in the art, and the general principles defined herein may be implemented in other embodiments without departing from the spirit or scope of the invention. Therefore, this application will not be limited to these embodiments shown herein, but is to be accorded the widest scope consistent with the principles and novel features disclosed herein.

What is claimed is:

1. An apparatus, comprising:
a magnetically permeable core and at least one coupled winding combination, wherein the at least one coupled winding combination comprises at least one main winding and at least one auxiliary winding;
wherein at least one portion of the at least one main winding is coupled with at least one portion of the at least one auxiliary winding;
wherein the apparatus has a first surface and a second surface opposite to the first surface; two ends of the at least one main winding are respectively exposed out of the magnetically permeable core on the first surface and the second surface; and two ends of the at least one auxiliary winding are respectively exposed out of the magnetically permeable core on the first surface and the second surface.

2. The apparatus of claim 1, wherein at least one portion of the at least one main winding is a first main winding segment, and at least one portion of the at least one auxiliary winding is a first auxiliary winding segment;
wherein the at least one portion of the at least one main winding coupled with the at least one portion of the at least one auxiliary winding is specifically:
the first main winding segment and the first auxiliary winding segment arranged side by side in parallel; a non-magnetic material or a magnetic material with a magnetic conductivity lower than that of the magnetically permeable core is set in an interval space between the first main winding segment and the first auxiliary winding segment.

3. The apparatus of claim 2, wherein all of the at least one main winding is the first main winding segment, and all of the at least one auxiliary winding is the first auxiliary winding segment;
wherein a coupling coefficient of the at least one main winding and the at least one auxiliary winding is greater than 0.85.

4. The apparatus of claim 2, wherein the at least one coupled winding combination comprises two main windings and at least two auxiliary windings; at least one portion of one of the main windings is a third main winding segment, at least one portion of the other main winding is a fourth main winding segment; and the third main winding segment is coupled with the fourth main winding segment.

5. The apparatus of claim 4, wherein the third main winding segment couples with the fourth main winding segment; the third main winding segment and the fourth main winding segment are arranged side by side or in parallel; and a non-magnetic material or a magnetic material with a magnetic conductivity lower than that of the magnetically permeable core is set in an interval space between the third main winding segment and the fourth main winding segment.

6. The apparatus of claim 4, wherein at least one portion of the at least one auxiliary winding corresponding to the third main winding segment is a third auxiliary winding segment, and at least one portion of the at least one auxiliary winding corresponding to the fourth main winding segment is a fourth auxiliary winding segment;
the third auxiliary winding segment is coupled with the third main winding segment; the fourth auxiliary winding segment is coupled with the fourth main winding segment;
the third auxiliary winding segment and the fourth auxiliary winding segment are arranged side by side between the third main winding segment and the fourth main winding segment.

7. The apparatus of claim 2, wherein the at least one coupled winding combination comprises two main windings and at least one auxiliary winding; one of the main windings is a first main winding, and the other main winding is a second main winding;
wherein a portion of the first main winding is a first main winding segment, and a portion of the second main winding is a second main winding segment; a portion of the auxiliary winding is a first auxiliary winding segment, and the other portion is a second auxiliary winding segment; the first auxiliary winding segment is coupled with the first main winding segment, and the second auxiliary winding segment is coupled with the second main winding segment.

8. The apparatus of claim 7, wherein the coupled winding combination comprises at least two symmetrically arranged auxiliary windings.

9. The apparatus of claim 7, wherein the at least one auxiliary winding, the first main winding segment and the second main winding segment are coplanar, and the first main winding segment and the second main winding segment are respectively located on two sides of the auxiliary winding.

10. The apparatus of claim 7, wherein the at least one auxiliary winding, the first main winding segment and the second main winding segment are both planar and are parallel to each other.

11. The apparatus of claim 7, wherein a portion of the first main winding is a third main winding segment, and the third main winding segment is not coupled with the auxiliary winding;
a portion of the first main winding is a fourth main winding segment, and the fourth main winding segment is not coupled with the auxiliary winding; the third main winding segment is coupled with the fourth main winding segment.

12. The apparatus of claim 11, wherein the third main winding segment couples with the fourth main winding segment; the third main winding segment and the fourth main winding segment are arranged side by side or in parallel; and a non-magnetic material or a magnetic material with a magnetic conductivity lower than that of the magnetically permeable core is set in an interval space between the third main winding segment and the fourth main winding segment.

13. The apparatus of claim 1, further comprising at least one first air gap, the first air gap being located on one side of the at least one main winding.

14. The apparatus of claim 13, wherein the first air gap passes through the apparatus in at least one first direction and extends to a surface of the apparatus in a second direction, and the first direction is different from the second direction;
wherein the first air gap divides the magnetically permeable core into at least two portions that are not in contact with each other.

15. The apparatus of claim 4, further comprising at least one first air gap, the first air gap being located on one side of the at least one main winding; and an interval space between the third main winding segment and the fourth main winding segment does not coincide with a position of the first air gap.

16. The apparatus of claim 15, further comprising at least one second air gap, at least one portion of the second air gap being located between the third main winding segment and the fourth main winding segment; wherein the second air gap and the first air gap together divide the magnetically permeable core into at least two portions that are not in contact with each other;
wherein a width of the second air gap is less than the first air gap.

17. The apparatus of claim 11, further comprising at least one first air gap, the first air gap being located on one side of the at least one main winding; and an interval space between the third main winding segment and the fourth main winding segment does not coincide with a position of the second air gap.

18. The apparatus of claim 17, further comprising at least one second air gap, at least one portion of the second air gap being located between the third main winding segment and the fourth main winding segment; wherein the second air gap and the first air gap together divide the magnetically permeable core into at least two portions that are not in contact with each other; wherein a width of the second air gap is less than the first air gap.

19. The apparatus of claim 1, wherein the at least one main winding is Z-shaped;
wherein the magnetically permeable core and the at least one coupled winding combination are integrally formed by pressing.

20. A voltage regulator module, comprising:
at least one two-phase voltage regulator module, wherein the at least one two-phase voltage regulator module comprises:
the apparatus of claim 1, wherein the number of main windings included in the apparatus is two, the number of auxiliary windings included in the apparatus is two, and the two auxiliary windings are respectively a first auxiliary winding and a second auxiliary winding;
a mainboard device group, wherein the mainboard device group comprises a top plate, and a switch device, an input capacitor and an auxiliary winding top pad disposed on the top plate;
a bottom plate, wherein the bottom plate comprises a power input pad, a power output pad, a first auxiliary winding external connection pad, a second auxiliary winding external connection pad, and an auxiliary winding bottom electrical connector;
a vertical electrical connector wherein the vertical electrical connector comprises a vertical power electrical connector, a first vertical auxiliary winding electrical connector and a second vertical auxiliary winding electrical connector, wherein two ends of the vertical electrical connector are respectively disposed on the first surface and the second surface of the apparatus;
wherein the mainboard device group is disposed on the first surface of the apparatus; the main winding is electrically connected to a corresponding switch device through a pad disposed on the first surface; the vertical power electrical connector is electrically connected to the switch device through the top plate; the first vertical auxiliary winding electrical connector is electrically connected to one end of the first auxiliary winding on the first surface through the top plate, and the second vertical auxiliary winding electrical connector is electrically connected to one end of the second auxiliary winding on the first surface through the top plate;
wherein the apparatus of claim 1 is electrically connected to the bottom plate through the second contact surface; one end of the main winding on the second surface is electrically connected to a corresponding output pad; the vertical power electrical connector is electrically connected to the power input pad; one end of the first auxiliary winding on the second surface is electrically connected to the first auxiliary winding external connection pad; one end of the second auxiliary winding on the second surface is electrically connected to the first vertical auxiliary winding electrical connector through the auxiliary winding bottom electrical connector; the second vertical auxiliary winding electrical connector is electrically connected to the second auxiliary winding external connection pad.

21. The voltage regulator module of claim 20, further comprising a load mainboard and at least two two-phase voltage regulator modules, wherein power input pads and power output pads of the two-phase voltage regulator modules are electrically connected in parallel through the load mainboard; the first auxiliary winding external connection pads and the second auxiliary winding external connection pads of etch of the two-phase voltage regulator modules are connected in series through the load mainboard to form an auxiliary winding loop.

22. The voltage regulator module of claim 21, wherein a coupling coefficient of the main winding and a corresponding auxiliary winding is greater than 0.85; the multi-phase voltage regulator module further comprises an externally connected compensation inductor, and the compensation inductor is connected in series in the auxiliary winding loop.
